(19) United States
(12) Patent Application Publication
(10) Pub. No.: US 2006/0212946 A1
(43) Pub. Date: Sep. 21, 2006

(54) System for the producing, controlling and using identification, authentication and traceability coded markings

(75) Inventor: Bernard Boulay, Poleymieux Au Mont D'or (FR)

Correspondence Address: OLIFF & BERRIDGE, PLC, P.O. BOX 19928, ALEXANDRIA, VA, 22320, US

(73) Assignee: CRYPTIC, Lyon (FR)

(21) Appl. No.: 10/535,410

(22) PCT Filed: Oct. 20, 2003
(86) PCT No.: PCT/FR03/03099

§ 371 Date: Mar. 8, 2006

(30) Foreign Application Priority Data
Dec. 6, 2002 (FR) 02/15464

(51) Int. Cl. G06F 11/00

(52) U.S. Cl. 726/34

(57) ABSTRACT

The invention is for the creation and use of coded markings which use threads or fibres with special properties, in particular magnetic, placed and inserted on or in a support, according to predefined lines, positions or areas. A first database (2), receiving the commands (5), is used to create, store and transmit the codes, with encryption. It controls, with respect to the quantity or length produced, at least one thread or fibre production machine (7). Another database (3), linked to the first database (2), receives the data concerning each production and controls at least one machine (9) for placing or inserting threads or fibres on or in a support, according to the code transmitted by the first database (2), controlling in particular the quantity of threads or fibres placed or inserted; it is also linked to readers (10) which are designed to recognize the codes and return an activity report.

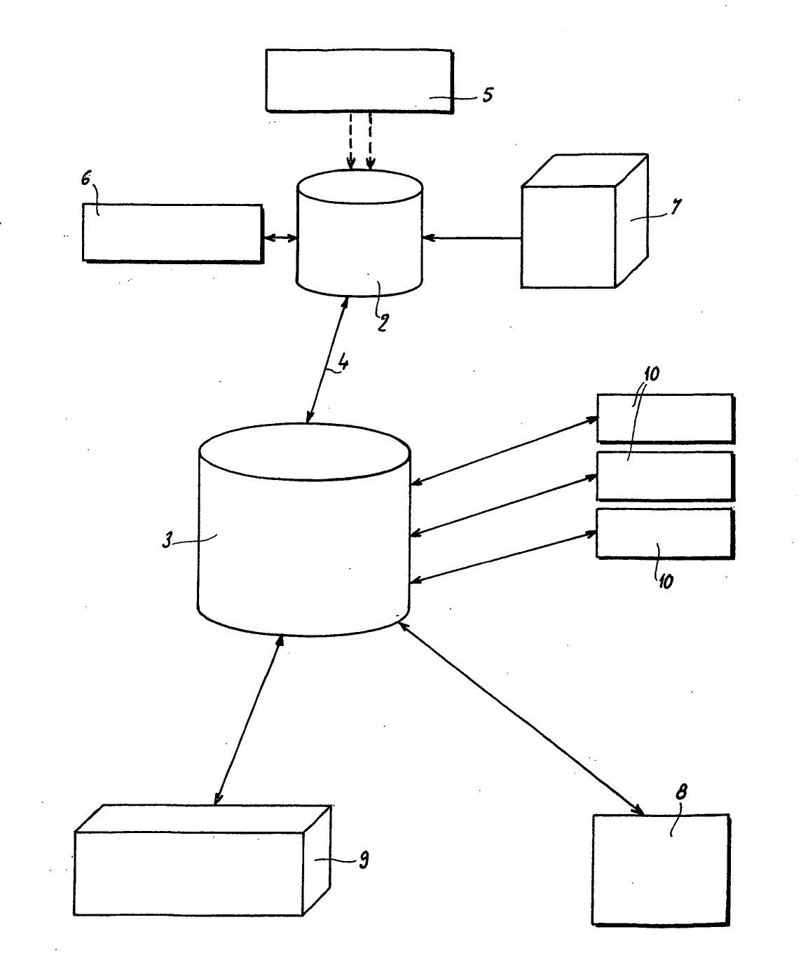

The present invention relates, generally, to the field of the identification, authentication or traceability of miscellaneous items, products or objects, by means of coded markings. It concerns, in particular, secured markings designed as magnetically coded labels, which can be “read” only using an appropriate detector, these markings being invisible to the naked eye, and also being imperceptible to the touch. Even more specifically, the invention covers identification, authentication or traceability markings which use threads or fibres with special magnetic properties, to be placed or inserted on or in a support, this invention being targeted more specifically on the production, control and use of such coded markings.

French Patent Application No. 02.04607, filed on 12 Apr. 2002, on behalf of the Applicant, published under No. 2 838 543, thus describes a magnetic marking system which comprises, on or in a support, correlated with predefined parallel positions separated by a constant interval according to a predefined template, one or more threads with ultra-soft ferromagnetic properties, these parallel threads being present or absent in each of said positions so as to form, by the assembly of the present or absent threads, a binary code detectable using an appropriate reader.

The support can in this case be formed by a sheet of adhesive material which fixes the threads with ultra-soft magnetic properties in their predefined positions; the adhesive support sheet can be covered by a protective sheet, of the silicon-treated paper type, which thus covers the threads. The above-mentioned patent application also describes a method and a machine for the production of the duly constituted magnetic markings.

In variants also provided for by this patent application, the threads with ferromagnetic properties are embedded in a moulded or formed material, or these threads are included in a textile support, the encoding principle remaining the same.

Other equivalent marking systems can use areas with special magnetic properties, these also forming a code
see for example document FR 2765014.

In particular, it concerns markings accompanying marketed items or products, these markings being required, in the manner of conventional “bar codes”, to identify said items or products, as well as their manufacturers or distributors. The problem of assigning these codes, and producing them, that is producing the coded markings, is by no means simple if the requirements stipulated below are to be taken into account:
Confidentiality and protection of the codes.
Multiplicity of parties involved: system manager; manufacturers of marking components (threads or fibres); producers of the markings themselves, also called “converters”; end users incorporating the markings in their items or products.
Requirements specific to the definition and assignment of the codes: not to create the same code twice, to delete the codes of out-of-date items or products, etc.
Desirable automation of the marking production process, in particular of the control of the machines for placing threads or fibres with ferromagnetic properties, so that these machines position the threads on their support correctly according to each adopted code.

There is therefore a real “management” need for this type of encoded marking, from a customer's order through to delivery and even beyond, encompassing the essential phase of controlling the production of said coded markings, taking into account all the requirements or other parameters.

The above-mentioned document FR 2765014 simply reaffirms the obvious requirement to store the codes, to be able to compare them with a code read on a product (in the event, a document whose authenticity is to be checked).

Other documents of the state of the art also disclose only very partial solutions, or are very limited in their application.

Document FR 2778987, which concerns a ski-theft-prevention identification method, provides for a database in which information is entered only when requested by a person, that is in case of loss or theft. The updating of the database is not automated.

Document EP 0919650 A1 concerns optically-encoded textile labels, which can be “read” at a number of points, and at various stages of their production or their use, by reading devices that are all linked to one and the same central memory. These reading devices do not themselves have any memory, and therefore contain no information, all the processing being done in the single central database. Furthermore, the document does not describe the generation and assignment of the codes, with recognition of the specific features of each order (number of items, etc).

To resolve the problems described above, the main object of the present invention is to devise a control system for the production, control and use of identification, authentication or traceability coded markings, using threads or fibres with special properties, in particular magnetic, to be placed or inserted on or in a support, according to predefined lines, positions or areas, the system comprising:
a first database creating, storing and transmitting codes, with encryption, triggered by the receipt of the commands and controlling, in particular with regard to the quantity or length produced, at least one machine for producing said threads or fibres;
a dedicated database, linked to the first database, which receives data concerning each production, and which controls at least one machine for placing or inserting threads or fibres on or in their support, controlling in particular the quantity of threads or fibres placed or inserted.

Thus, the invention proposes a complete system, which handles or controls the creation of the codes, the production of the threads or fibres in relation to each order, and the incorporation of these threads or fibres in “labels” according to the code corresponding to each order. This system controls in particular, for each order which relates to a defined batch of product items, the production and the delivery of the quantity of threads or fibres strictly needed to produce the corresponding labels. The system also handles the direct control, in “real time”, of the production of these labels, that is, of the placement or insertion of the threads or fibres, as specified below. According to another essential aspect of the invention, the system mainly uses the codes in an encrypted form, which does not directly represent the binary code resulting from the spatial disposition of the marking threads or fibres.

According to an embodiment of the system, the codes of the markings are generated randomly by the first database.

Preferably, the two databases are interlinked by a secured link.

The codes can be transmitted from the first database to the dedicated database either continuously or periodically.

Advantageously, the dedicated database is connected to readers associated with the users, each reader receiving only the codes specific to the corresponding user, and being designed also to return to said database an activity report.

The system that is the object of the invention is also designed to send placement or insertion order forms, intended to accompany the threads or fibres produced, defining their disposition corresponding to the assigned coding, in particular by a code in encrypted form, this for the thread or fibre placement or insertion machine. This machine decrypts the encrypted code of the order form, to carry out the placement or insertion according to the binary code created.

The invention will be better understood from the description that follows, with reference to the appended diagrammatic drawing, the single figure of which represents, in block diagram form, the system for the production, control and use of markings that is the object of the invention.

This system is characterized in particular by the combination of two databases, respectively denoted 2 and 3, which are interlinked by a secured link 4.

The first database 2 is accessible only by the system manager, who enters into it the orders from his customers, symbolized in 5. The database 2 creates, stores and transmits codes, generated randomly, in association with an encryption module 6. This database 2 is also connected to a machine 7 for producing threads or fibres, encoded marking components, controlling the quantity or length of the threads or fibres produced by the machine 7.

The database 2 transmits the codes to the other database 3, via the secured link 4, continuously or periodically, for example once a day. This other database 3 is accessible to any customer, symbolized in 8.

The dedicated database 3 is connected to a machine 9 for placing or inserting threads or fibres in or on a support, therefore a machine which produces the markings of the type that is of concern here. In particular, the database 3 monitors the quantity of threads or fibres placed or inserted by the machine 9.

This database 3 is also connected to readers 10, associated with the different users. Each reader 10 receives only the codes specific to the corresponding user.

In practice, system operation is as follows:

A customer sends an order 5, which includes a certain number of indications: customer name, name of product or item to be marked, quantity of products or items (therefore of markings required), format of the “labels” themselves constituting or receiving the markings, identification of the batch of products or items, production date, etc. If the order 5 is accepted, the latter is entered in the database 2, and is confirmed.

The database 2 then automatically creates a code, assigned to this order 5, which is a binary code, corresponding to the actual disposition of the marking threads, as it could be perceived “visually”. This binary code is generated more or less randomly, that is, it is not entirely arbitrary but depends on certain parameters, in particular on the format of the “labels”. Of course, during this code generation process, codes already previously created or assigned are excluded.

Using the encryption module 6, the database 2 creates, from the previously created binary code, an encrypted code which is stored and transmitted by this database 2. Each binary code has a corresponding single encrypted code, and vice versa, the encrypted code being a code that does not correspond “visually” to the disposition of the threads of the marking.

At this stage, it is important to note that the duly created binary code remains internal to the system; it does not have to be displayed, and is in theory not known to any person.

The database 2, which thus contains a code assigned to the order 5 concerned, also, according to the characteristics of this order 5 and the corresponding code (with more or less numerous threads), will calculate the length of thread needed, or the equivalent quantity of fibres required, to produce all of the markings for the order concerned. This calculated length or quantity can be expressed in the form of a whole number of reels of thread (each reel corresponding to a predefined length of thread, known in advance).

From this information, the database 2 starts production of the threads or fibres by the machine 7, so that the latter produces the length or quantity required. Conversely, the machine 7 reports to the database 2 on the fact that the threads or fibres have been produced, in the required quantity (expressed in particular as a number of reels).

Simultaneously, the database 2 transmits via the secured link 4, to the other database 3, information according to which the threads or fibres are currently being produced, then further information when the threads are all produced and shipped.

These threads or fibres themselves, once produced, are sent to the “converter”, that is to the establishment or workshop equipped with the machine 9 for placing or inserting the threads or fibres in or on a support. The duly shipped threads or fibres are accompanied by a delivery advice note which also constitutes a placement or insertion order form, issued by the system, and defining the disposition according to which the threads or fibres must be placed or inserted, to form the code assigned to the order concerned. This order form contains the corresponding code in its previously created encrypted form.

The placement or insertion machine 9 has an interface, which enables it to “read” the information on the delivery advice note, in order to carry out the placement or insertion of the threads or fibres according to the code definition contained in this order form. In particular, this interface decrypts the code contained in the order form, to restore the binary code which corresponds directly to the disposition of the threads. This machine 9 works, for example, by placing simultaneously a number of parallel threads on an adhesive support in tape form, continuously, the transverse positioning of the threads being carried out in correspondence with the code adopted for the marking. The resulting continuous tape is then cut into sections, to obtain individual “labels”, with incorporated threads.

The placement or insertion machine 9 returns, to the database 3, the definition of the code in encrypted form and the length or quantity produced, in the form of an activity report which can also mention any operating errors, detected during the placement operation. In as much as the database 3 can be queried by the customer 8, the latter can, at any time, check the progress of his order.

Once produced, the coded “labels” are themselves shipped to their recipient, who places them or fixes them on the corresponding products or items.

Over and above simply consulting the dedicated database 3, the customer 8 can remotely request a modification, for example the “disabling” of a particular code corresponding to an out-of-date product.

Finally, the readers 10, associated with one or more customers 8, are informed of the codes specific to the or each customer received in encrypted form from the database 3, each reader 10 being identified by a number. The codes contained in each reader 10 are regularly updated. Conversely, each reader 10 returns to the database 3, for example once a day, an activity report to ensure the traceability of the marked products or items. It will be noted that, inside each reader 10, the comparison between a “read” code and a stored code is performed in the encrypted form, the binary code detected on a marking first being converted into encrypted code, using an encryption module identical to the one used by the first database 2.

The links between the various elements of the system can be provided by the INTERNET network, the particular link 4 between the two databases 2 and 3 being in this case a secured INTERNET link.

The use of the threads or fibres, components of the magnetic markings produced, is thus entirely controlled by the system, avoiding in particular any excess length or quantity of threads or fibres assigned to a code, in order to prevent an excessive or fraudulent use.

The system is also easy to adapt and open-ended: it can assign a different code to each batch or series of products or items, a code which corresponds to a number and/or a distinct positioning of the threads or fibres. Furthermore, it is possible to envisage assigning an additional code to allow for the individual identification of each product or item, within a batch or a series, for total traceability.

There would be no departure from the spirit of the invention, as defined in the appended claims, regardless of:
the nature of the threads or fibres, or the detail of their properties;
the number and the specific features of the thread or fibre production machines, and of the thread or fibre placement or insertion machines, which are controlled by the system;
the detail of the information interchanged between the elements of the system;
the nature of the links between the elements of the system.

1. System for the production, control and use of identification, authentication or traceability coded markings, using threads or fibres with special properties, in particular magnetic, to be placed or inserted on or in a support, according to predefined lines, positions or areas, characterized in that it comprises:
a first database creating, storing and transmitting codes, with encryption, triggered by the receipt of the commands and controlling, in particular with regard to the quantity or length produced, at least one machine for producing said threads or fibres;
a dedicated database, linked to the first database, which receives data concerning each production, and which controls at least one machine for placing or inserting the threads or fibres on or in their support, controlling in particular the quantity of threads or fibres placed or inserted.

2. System according to claim 1, characterized in that the codes are generated randomly by the first database.

3. System according to claim 1, characterized in that the two databases are interlinked by a secured link.

4. System according to claim 1, characterized in that the codes are transmitted from the first database to the dedicated database continuously.

5. System according to claim 1, characterized in that the codes are transmitted from the first database to the dedicated database periodically.

6. System according to claim 1, characterized in that the dedicated database is linked to readers associated with the users, each reader receiving only the codes specific to the corresponding user, and being designed also to return to said database an activity report.

7. System according to claim 1, characterized in that it sends placement or insertion order forms, designed to accompany the threads or fibres produced, defining their disposition corresponding to the assigned coding, in particular by a code in encrypted form.
